(19) United States
(12) Patent Application Publication
(10) Pub. No.: US 2004/0260915 A1
(43) Pub. Date: Dec. 23, 2004

(54) Method for executing a single directive of a program in a programmable logic controller

(76) Inventor: Tsang-Yi Lin, Taoyuan (TW)

Correspondence Address: RABIN & CHAMPAGNE, P.C., Suite 500, 1101 14 Street, N.W., Washington, DC, 20005, US

(21) Appl. No.: 10/650,795

(22) Filed: Aug. 29, 2003

(30) Foreign Application Priority Data
Jun. 13, 2003 (TW) 92116106

(51) Int. Cl. G06F 9/00

(52) U.S. Cl. 712/227

(57) ABSTRACT

A method for executing a single directive of a program in a programmable logic controller is used for debugging the program. When the PLC is in a single directive mode, it executes a determined program one directive at a time, as it receives execution commands. Once executing the directive, the PLC stops executing the program and waits to receive another execution command to execute the next directive. Without another execution command, the PLC stays in a standby mode. Hence the users can debug the program easily.

### BACKGROUND OF THE INVENTION

1. Field of Invention

The invention relates to a method for executing a single directive of a program in a programmable logic controller.

2. Related Art

Programmable logic controllers (PLCs) are powerful tools for process control. Nowadays, operations of automated processes in factories are mostly performed by programmable logic controllers. Basically, a PLC is a small computer specially designed for the system that controls these processes. Users may write programs into the memory module through software, a writing device, and a human-computer interface provided by factories. The central processing unit (CPU) of the PLC monitors and processes input signals from button keys, and sensors or limit switches according to the control logic defined in the programs. After a logic determination, output signals are sent to outer loads such as relays, indicating lights, electromechanical apparatus, or the like. On some occasions, and depending on the requirements of the production line, the output signals may be fed back to become input signals and control other output facilities.

Generally speaking, the PLC has a directive database defining different directives with a specific form for users to write different programs when needed. A desired program composed of directives, such as load, output, move, pick, and save, controls the motion of the PLC correctly and effectively. “Debug” is a must action for a program to execute the motions that users require the PLC to perform correctly.

In general, a program is executed from the first directive to the last directive to make the PLC perform the motions corresponding to the directives. For example, a program is composed of the directives of load, output, and move in order, users can only execute the program from the first directive “load” to the third directive “move” or not execute the program. Thus, many difficulties exist in debugging a finishing program. A huge program composed of many directives is hard to debug by executing from the first directive to the last directive, and some directives are easily lost.

### SUMMARY OF THE INVENTION

The method for executing a single directive of a program in a programmable logic controller is used to change the PLC to a single directive mode, so the program can be executed by the PLC one directive at a time to increase the efficiency of debugging.

The method for executing a single directive of a program in a programmable logic controller is illustrated below. First, the PLC is changed to a single directive mode, and the PLC stays in a standby mode. When the PLC receives an execution command aimed at the program, the PLC executes the first directive of the program. The PLC stops executing the program after executing the first directive. Then, the PLC receives another execution command and executes the next directive repeatedly until executing all the directives of the program for users to debug the program easily.

The method described in the invention can be used to debug the program after it is written, to determine which directive of the program is unexpected by executing the program one directive at a time. Thus, the faulty directive of the program can be located and corrected easily to achieve the purpose of debugging.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a flowchart of the invention.

### DETAILED DESCRIPTION OF THE INVENTION

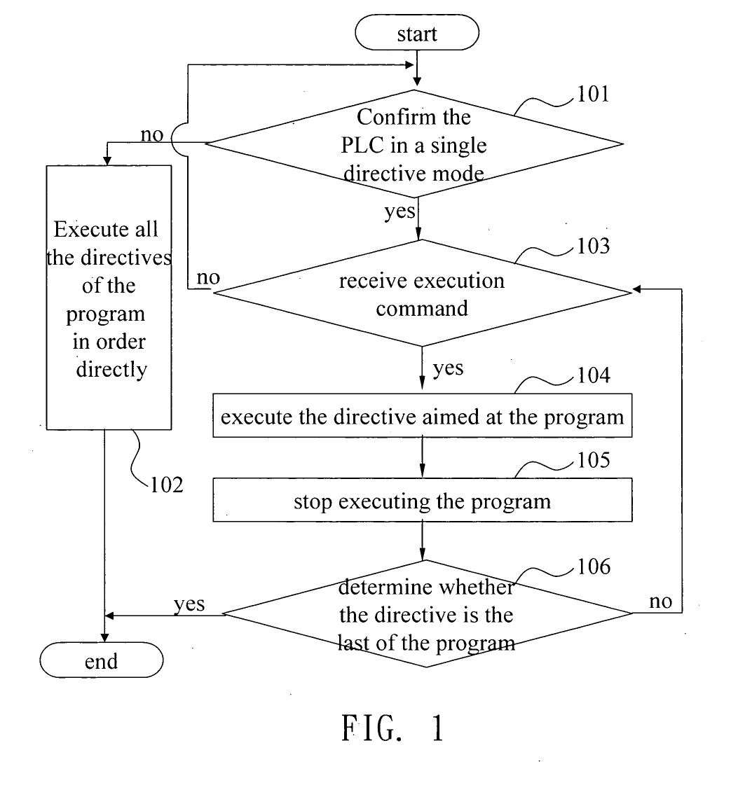

As shown in FIG. 1, a method for executing a single directive of a program in a programmable logic controller is illustrated below. First, confirm whether the PLC (programmable logic controller) is in a single directive mode or not (step 101). If the PLC is not in the single directive mode, the PLC stays in a general execution mode and executes all the directives of the program in order directly (step 102). If the PLC is in the single directive mode, the PLC stays in a standby mode and waits to receive another execution command to execute the next directive of the program (step 103). Of course, if the PLC does not receive the execution command for a determined time, the PLC returns to step 101 automatically, waits until users input another execution command, or waits until users cancel another execution command.

As the PLC receives another execution command that users input (step 103), the PLC executes the directive aimed at the program (step 104). The PLC stops executing the program (step 105) after executing the directive. Then the PLC determines whether or not the directive is the last of the program (step 106). If the directive is the last directive of the program, the method ends. If the directive is not the last directive of the program, the PLC returns to step 103 and waits to receive another execution command to execute the next directive of the program.

For example, a program in a PLC is composed of several directives LD X0, OUT Y0, LD X1, OUT Y1, LD X2, OUT Y2, and END. When the PLC is in a general execution mode, it executes all the directives of the program in order directly. Once the PLC is changed to a single directive mode, the PLC stays in a standby mode, and waits to receive an execution command input by users. When the PLC receives the first execution command, the PLC executes the first directive “LD X0”, then stops executing the program and waits to receive next execution command input by users. After receiving the next execution command, the PLC executes the second directive “OUT Y0”. The PLC executes the program in this way until it executes the last directive “END”, then turns to the first directive “X0” and continues executing one directive at a time. Until users cancel the action of executing a single directive or stop executing the program, the PLC continues executing the program.

The method described in the invention can be used to debug the program after it is written, to determine which directive of the program is unexpected by executing the program one directive at a time. Thus, the faulty directive of the program can be located and corrected easily to achieve the purpose of debugging.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for executing a single directive of a program in a programmable logic controller, comprises the steps of:
confirming the PLC in a single directive mode;
receiving an execution command aimed at the program by the PLC;
executing a directive of the program by the PLC; and
stopping executing the program and waiting to receive another the execution command to execute a next directive after executing the directive of the program by the PLC.

2. The method of claim 1, wherein the result of the step of confirming the PLC in a single directive mode is no, executing all the directives of the program in order directly.

3. The method of claim 1, wherein the step of stopping executing the program and waiting to receive another the execution command to execute a next directive after executing the directive of the program by the PLC, if the PLC receiving no another the execution command, the PLC stays in a standby mode.

4. The method of claim 3, wherein as the PLC stays in a standby mode, the PLC stops the single directive mode directly.

5. The method of claim 1, wherein after the step of stopping executing the program and waiting to receive another the execution command to execute a next directive after executing the directive of the program by the PLC comprises a step of determining the directive is the last of the program by the PLC.

6. The method of claim 5, wherein the result of the step of determining the directive is the last of the program by the PLC is yes, then the PLC stops the single directive mode, and the result of the step of determining the directive is the last of the program by the PLC is no, then the PLC continues waiting to receive another the execution command to execute a next directive after the directive of the program.
